(19) United States
(12) Patent Application Publication
(10) Pub. No.: US 2002/0097975 A1
(43) Pub. Date: Jul. 25, 2002

(54) Device allowing the end of an optical fiber to be positioned and held in place inside a substrate

(75) Inventors: Arnaud Delpoux, Meylan (FR); Jean-Michel Karam, Grenoble (FR); Marie-Ange Iannello, Sassenage (FR); Nan Zhang, Chanhassen, MN (US); Gary Nault, Bloomington, MN (US)

Correspondence Address: WALL MARJAMA & BILINSKI, 101 SOUTH SALINA STREET, SUITE 400, SYRACUSE, NY, 13202, US

(73) Assignee: MEMSCAP, SAINT ISMIER (FR)

(21) Appl. No.: 10/024,682

(22) Filed: Dec. 18, 2001

(30) Foreign Application Priority Data
Dec. 19, 2000 (FR) 00 16576

(51) Int. Cl. G02B 6/00; G02B 6/36

(52) U.S. Cl. 385/137; 385/83

(57) ABSTRACT

Device allowing the end (4) of an optical fiber (3) to be positioned and held in place inside a substrate (1), wherein:

the substrate (1) has a groove (2) intended to accommodate the end (4) of the optical fiber (3), said groove (2) possessing at least one plane wall (8) perpendicular to the principal plane (9) of the substrate (1);

the groove (2) includes a moveable part (5), located on the face opposite the plane wall (8) and capable of moving toward said plane wall (8) between two positions, namely;

a retracted position in which the end of the optical fiber (3) can penetrate freely into the groove (2);

a locked position in which the moveable part (5) comes into contact with the optical fiber (3) in order to press it against said plane wall (8);

it includes means (21, 24) allowing a force to be exerted on the moveable part (5) in order to cause it to move with respect to the plane wall (8)

### TECHNICAL FIELD

The invention relates to the field of microelectronics and more specifically to systems for aligning optical fibers. It relates more particularly to a device allowing the end of an optical fiber to be positioned and held in place inside a substrate. The invention can be applied in very many components such as switches and attenuators, or more generally any microelectronic component, connected to optical fibers.

### PRIOR ART

As is known, optoelectronic components connected to optical fibers are particularly sensitive to alignment stresses. This is because alignment errors are very important loss factors in optical systems, especially in the case of switches, in which the various fibers must be placed precisely in the optical path of one another.

It is therefore recognized that the positioning of optical fibers inside a substrate must be carried out with the greatest possible precision, especially because of the small diameter of the optical fibers conventionally used, which is about 125 micrometers.

Several solutions have already been proposed to ensure precise positioning of the optical fiber, but all these solutions have drawbacks. Thus, document U.S. Pat. No. 5,276,762 describes a solution consisting in placing the optical fibers in V-shaped grooves. These grooves, generally called V-grooves, house the optical fiber with contact along two generatrices of the latter. The solution described in that document consists in covering the ends of the optical fibers with a sheath made of a magnetic material. A magnetic field is applied near the ends of the fiber in order to generate a force which presses the end of the fiber against the substrate.

This arrangement allows the optical fibers to be held in place in the grooves, however it does have drawbacks. This is because the end of the optical fiber is covered with an additional sheath whose thickness must be calibrated and constant in order not to generate optical fiber alignment errors.

Furthermore, the presence of this additional sheath increases the dimensions of the alignment device and therefore its size. This size is also increased because of the presence of the electromagnetic circuit needed to apply the magnetic holding field.

Furthermore, to ensure that the fiber is held permanently in place, it is necessary to apply the magnetic field permanently. This consumes considerable power. Finally, the magnetic material used to form the additional sheath and the presence of the magnetic holding field may cause perturbations in the optical system.

Document U.S. Pat. No. 6,101,306 has proposed another solution, which consists in placing the ends of the optical fibers in a groove, then in covering them with an adhesive and finally in fitting an upper structure forming a lid. Capillary effects between the groove and the lid reduce the formation of air bubbles inside the adhesive, thereby improving the adhesion of the optical fiber. Although this solution allows the optical fiber to be held firmly in place, it does nevertheless have many drawbacks.

This is because positioning the fiber in its alignment structure is definitive. Once this alignment has been made, it is impossible to modify it or even to change the optical fiber without damaging the device. Furthermore, alignment of the optical fiber along the groove is not actually ensured since the distribution of the adhesive between the optical fiber and the groove may be random, or in any case not controlled. Thus, the gap existing between the optical fiber and the edges of the groove may vary along the bonding zone. This may cause alignment errors, or even bends in the optical fiber which give rise to energy losses.

Another solution is also known, which consists in using U-shaped grooves, or more generally grooves with two side walls perpendicular to the principal plane of the substrate. Such a groove is provided on its lateral faces with several small flexible blades forming springs. These blades are oriented in the direction of penetration of the fiber into the substrate. When the optical fiber is placed in the groove, the small lateral blades are deformed and, owing to their elasticity, exert a holding force on the fiber. The fiber is then adhesively bonded in order to ensure that it is held in place definitively.

This solution has a number of drawbacks. Firstly, the optical fiber is held in place definitively, since it is bonded to the inside of the groove. Secondly, even before bonding, it is very difficult to modify the position of the optical fiber inside the groove, since pulling on the fiber generates large stresses in the regions of contact with the inclined blades, which have a tendency to oppose any retraction of the fiber.

Furthermore, the centering of the optical fiber, and therefore its alignment, is defined by the relative stiffnesses of the various blades placed on either side of the fiber, so that a difference in stiffness of these blades necessarily generates an alignment error.

Moreover, such a geometry is determined for one particular optical fiber diameter and cannot accommodate fibers of different diameters.

Document EP 0 429 877 has described a device allowing optical fibers to be positioned and held in place in a substrate. Such a device comprises a substrate portion which forms a deformable blade providing a spring effect. The major drawback with this solution lies in the fact that a certain pressure is exerted on the fiber as it is being fitted into the substrate. The presence of stresses exerted non-uniformly on part of the optical fiber may prejudice the quality of the fitting operations.

Furthermore, such a device does not allow the optical fibers to be repositioned at will, since the optical fibers are locked in position by the presence of a cover portion, preventing the flexible portions forming springs from being able to deform.

Also described, in document EP 0 515 784, is a device for locking optical fibers inside a substrate. This device operates by locking the optical fibers in pieces forming moveable wedges. More specifically, the optical fiber is placed between two pieces, one end of which forms a bevel, and which can slide inside a piece forming a complementary bevel. Such a device has several drawbacks, and especially the fact that the optical fiber is positioned definitively since, when the two beveled portions are fitted together, it is impossible to move them and therefore to reposition the optical fiber in a different manner.

Furthermore, the precision in positioning the fiber transversely is not optimal as it depends on the differences in stiffness and in deformability of the various beveled pieces. In other words a slight difference in the shape of the bevels lying on either side of the fiber can cause a lateral shift of the fiber, and therefore an alignment error.

One problem that the invention therefore aims to solve is that of ensuring that the end of the optical fiber is firmly held in place, while retaining the possibility of adjusting the positioning after the first fitting.

Another problem that the invention aims to solve is that of ensuring that the fiber is perfectly aligned with respect to a fixed reference region of the substrate.

### SUMMARY OF THE INVENTION

The invention therefore relates to a device allowing the end of an optical fiber to be positioned and held in place inside a substrate.

This device is noteworthy in that:

the substrate has a groove intended to accommodate the end of the optical fiber, said groove possessing at least one plane wall perpendicular to the principal plane of the substrate;

the groove includes a moveable part, located on the face opposite the plane wall and capable of moving toward said plane wall between two positions, namely;

a retracted position in which the end of the optical fiber can penetrate freely into the groove;

a locked position in which the moveable part comes into contact with the optical fiber in order to press it against said plane wall;

it includes means allowing a force to be exerted on the moveable part in order to cause it to move with respect to the plane wall.

In other words, the groove made in the substrate has a wall which constitutes a reference wall for positioning the optical fiber. The optimum alignment position of the optical fiber is located very precisely by the construction of this referencing wall with respect to the substrate. According to the invention, the moveable part of the groove can be moved, either to allow penetration of the optical fiber into the groove or to prevent it from being retracted therefrom, while pressing it against the referencing wall, and therefore ensuring optimum alignment.

The movement of this moveable part may be controlled as desired, so that it is possible to retract the moveable part in order to fit the optical fiber, or else move it closer to the wall forming the referencing wall when it is desired for the optical fiber to be held in place.

The latter is therefore subjected to no unnecessary mechanical stress. It can be repositioned at any moment, allowing the alignment to be adjusted in an optimum manner.

According to another characteristic of the invention, the device may also include return means capable of opposing any movement of the moveable part under the action of the characteristic force.

In other words, the characteristic moveable part can move in one direction, owing to the effect of the controlled force, and in the opposite direction when this force disappears, only the return means being active.

According to various embodiments, the means allowing the characteristic force to be exerted on the moveable part allow the latter to move either from the retracted position to the locked position, or from the locked position to the retracted position.

In other words, application of the characteristic force can cause the groove to open or widen and the optical fiber to be released or, conversely, the optical fiber to be pinched when the latter is already in place in the groove.

In practice, the return means may advantageously be formed by two beams made in the substrate, which connect the moveable part to the rest of the substrate, these two beams being oriented approximately parallel to the principal axis of the groove. Consequently, the beams are stressed either in bending or in buckling. The return means may, in certain embodiments, consist of a spring-type structure.

The nature of the characteristic force exerted on the moveable part may vary very greatly. Preferably, it will be of electrostatic nature, but it may also be of electrothermal, piezoelectric, magnetostatic or simply mechanical origin.

Thus, in the electrostatic version of the invention, the means for exerting the characteristic force on the moveable part may comprise two arrays of blades forming two interdigitated combs, one of these combs being integral with the moveable part and the other comb being integral with the rest of the substrate.

Application of an electrical voltage between the two combs makes them move closer together, and therefore makes the moveable part move with respect to the rest of the substrate.

According to the embodiments already mentioned, application of the electrical voltage may cause the moveable part to pass from the retracted position to the locked position, removal of this voltage allowing the return means to cause the moveable part to return to the retracted position. This first embodiment may, for example, be used to ensure that the optical fiber is temporarily locked in place just after it has been inserted. It is thus possible to position the optical fiber definitively by means of suitable adhesive bonding and then to remove the voltage applied between the combs, so that the moveable part moves away from the optical fiber and returns to the retracted position.

In a second embodiment, application of the electrical voltage may cause the moveable part to pass from the locked position to the retracted position, removal of this voltage allowing the return means to cause the moveable part to return to the locked position.

In other words, the moveable part lies, by default, in the locked position thanks to the action of the return means. When fitting the optical fiber, applying the voltage moves the moveable part away from the center of the groove and thus permits the optical fiber to be fitted. When the optical fiber has been suitably positioned, canceling the voltage between the two characteristic combs cancels the electrostatic force. The return means then cause the moveable part to return to the locked position in such a way that the optical fiber is pressed against the referencing wall in the groove.

This solution has the advantage that electrical power is consumed only during the operations of fitting the optical fiber, consumption then being zero when alignment has been achieved since the fiber is held in place by the force applied by the return means.

### BRIEF DESCRIPTION OF THE FIGURES

The manner of realizing the invention and the advantages which stem therefrom will become clearly apparent from the description of the embodiment which follows, supported by the appended figures, in which:

FIG. 1 is a top view of the region of the substrate which includes the groove and the moveable part according to the invention, in which the moveable part is shown in the locked position;

FIG. 2 is a sectional view in the plane II-II′ of FIG. 1;

FIG. 3 is a sectional view, similar to that of FIG. 1, in which the moveable part is shown in the retracted position; and

FIG. 4 is a sectional view on a plane IV-IV′ of FIG. 3.

### MANNER OF REALIZING THE INVENTION

As already mentioned, the invention relates to a device for holding an optical fiber in place inside a substrate, able to form part of microcomponents varying very widely in size, such as switches, attenuators or any optoelectronic microcomponent.

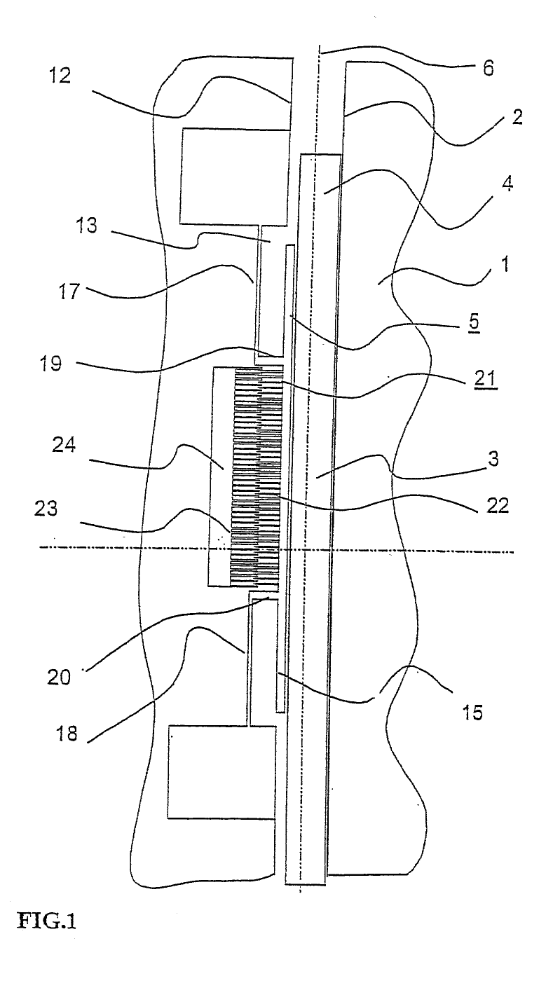

A non-limiting example of such a device is illustrated in FIG. 1. In general, the substrate 1 includes a rectilinear groove 2 inside which the end 4 of an optical fiber 3 may be housed. According to the invention, the groove is provided with a moveable part 5 capable of moving perpendicular to the longitudinal axis 6 of the groove.

More specifically, the geometry of the groove 2 is such that it allows precise positioning and perfect alignment of the optical fiber. Thus, the groove 2 has a side wall 8 which is perpendicular to the principal plane 9 of the substrate. This side wall 8 constitutes the positioning reference with respect to which the optical fiber 3 has to be placed in order to obtain optimum alignment. The groove 2 also has a flat bottom 10 on which the optical fiber 3 can rest. The groove 2 also has another side wall 12, the shape of which is not critical, but which may advantageously be plane.

The side wall 12 is interrupted in the region where the moveable part 5 is present. More specifically, the side wall 12 defines a housing 13 inside which the moveable part 5 may be placed, and where the means allowing a force to be exerted on the moveable part 5 are located. More specifically, the moveable part 5, as illustrated in FIG. 1, has a longitudinal plate 15 of substantially parallelepipedal geometry. The principal face of this plate 15 is parallel to the side walls 8, 12 of the groove. This plate 15 is connected to two beams 17, 18 via two segments 19, 20 which are perpendicular to the principal plane of the plate 15.

More specifically, the beams 17, 18 form small flexible blades approximately parallel to the longitudinal axis 6 of the groove when the moveable part 5 is in the locked position 5 as illustrated in FIG. 1.

Between the segments 19, 20 connecting the beams 17, 18 to the plate 15, the moveable part 5 has a plurality of uniformly spaced blades 22 perpendicular to the plate 15 and directed toward the outside of the groove 2. These blades 22 together form an equipotential comb 21.

The housing 13 facing the comb 21 formed by the blades 22 has a complementary comb 24, comprising evenly spaced blades 23. The various tines 23 of the comb 24 lie between the blades 22 of the comb 21 of the moveable part 5.

In the position illustrated in FIG. 1, the moveable part 5 is in its locked position corresponding to the situation in which it is closest to the plane wall 8 of the groove 2.

In this situation, the tines 22, 23 of the combs 21, 24 have a fraction of their length overlapping one another. Thus, application of a DC voltage between the moveable part 5 and the comb 24 causes an electric field to exist between the areas of overlap of the blades 22 and 23. The blades 22 of the moveable part 5 are therefore attracted by the blades 23 of the fixed comb 24.

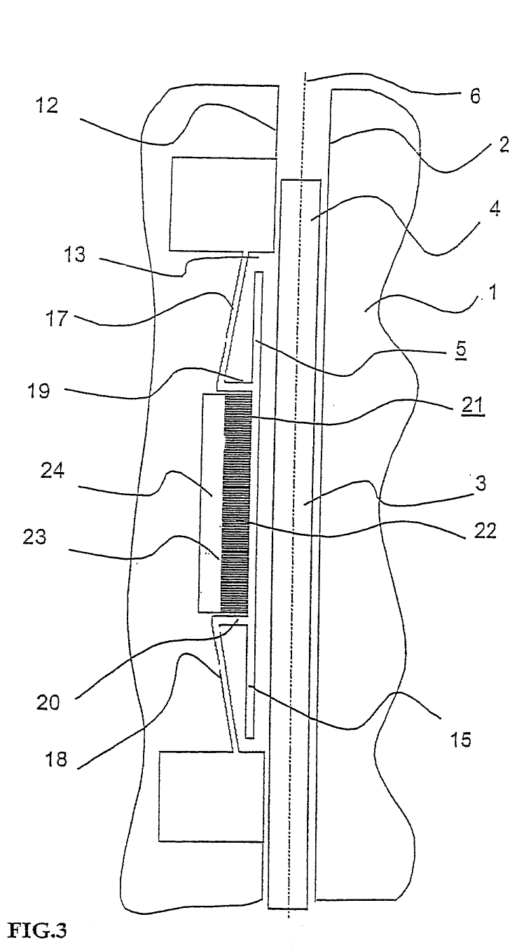

The moveable part 5 therefore moves as illustrated in FIG. 3, in which it may be seen that the blades 22 of the comb 21 have penetrated between the blades 23 of the comb 24 in order to maximize the areas of overlap.

Movement of the plate 15 deforms the beams 17, 18 which prevent the plate from moving toward the outside of the groove. The equilibrium position is reached when the electrostatic force existing between the combs 21, 23 is equal to the mechanical reaction of the beams 17, 18 which are oriented toward the groove 2.

It should be noted that this equilibrium position may be varied according to the DC voltage applied between the combs 21 and 24.

In the embodiment illustrated in FIG. 3, the plate 15 is retracted inside the housing 13 so that the face of the plate 15 which is oriented toward the groove lies beyond the position of the side wall 12 of the groove.

The groove 2 then has its maximum width, thereby allowing the end 4 of the optical fiber to be inserted without hindrance.

In practice, an optical fiber is fitted in the following manner.

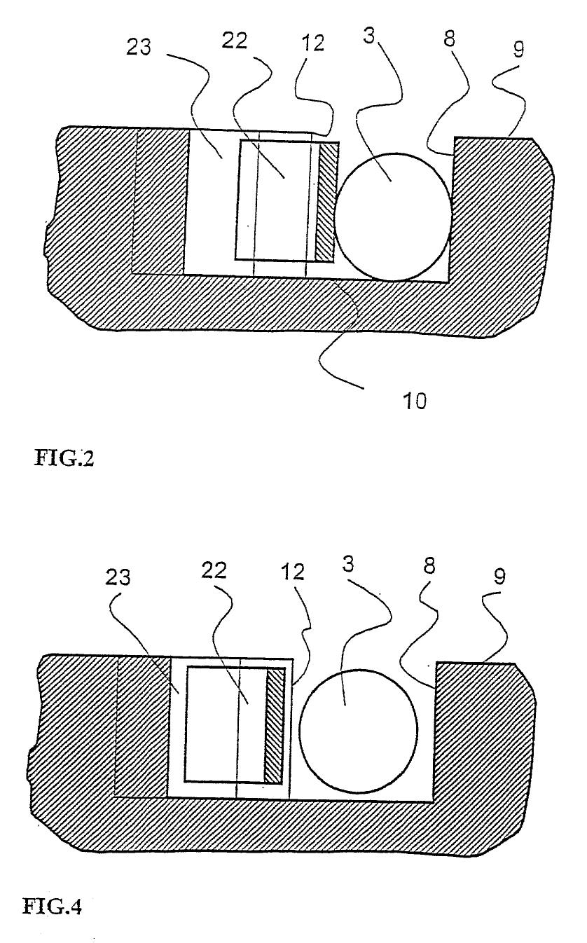

Firstly, a DC voltage is applied between the two combs 21 and 24 in order to retract the moveable part 5 inside the housing 13 of the substrate. The optical fiber 3 is inserted into the substrate in the groove 2. When the length of fiber inserted into the substrate is sufficient, the DC voltage between the combs 21 and 24 is removed. The beams 17 and 18 resume their rest position, entraining in their movement the plate 15. This plate 15 therefore comes into contact with the optical fiber 3, as illustrated in FIGS. 1 and 2. The force exerted by the plate 15 on the fiber 3 presses the latter against the wall 8 of the groove 2. When the optical fiber 3 is in contact with the wall 8, it is positioned very precisely with respect to the positional reference that this wall 8 constitutes.

Furthermore, the pressing force exerted by the beams 17, 18 via the plate 15 on the optical fiber 3 is such that it ensures that the fiber 3 is held in position in the groove 2.

As an example, the pressure exerted on the fiber may be as high as about one mega pascal (1 MPa) for an optical fiber 125 microns in diameter, which comes into contact with the plate 15 over a length of 2.4 millimeters, and for a contact height of around 5 microns.

Of course, this pressing force may be varied by the mechanical properties of the beams 17, 18 and by the length of the plate 15 measured in the longitudinal direction of the groove.

It should be noted that the pressing force may be canceled at any moment by applying a voltage between the combs 21 and 24. Consequently, it is possible to adjust the length of insertion of the optical fiber without any risk of damaging it.

In the embodiment illustrated, the rest position of the moveable part, that is to say for a zero voltage between the combs 21 and 24, corresponds to a locked position in which the optical fiber is held in place inside the groove 2.

The voltage is applied only when it is desired to retract the moveable part 5, that is to say during the phases of fitting the optical fiber 3. This solution is advantageous with regard to power consumption by the device.

As already stated, the pair of combs 21, 24, where an electrostatic force is created, may be replaced with any other means of different nature allowing a force to be exerted on the plate 15 perpendicular to the axis 6 of the groove 2.

This may, for example, be a mechanism operating by electrothermal actuation. Such an actuator may include bimetallic strips operating on the principle of differences in expansion of two materials combined together as adjacent layers. When an electric current flows through the bimetallic strips, they dissipate power which causes them to undergo expansion which differs according to the materials.

In an alternative version, the same material may be used for both parts of the actuator, these two parts having a different geometry. This induces different heating and therefore differential expansion.

In practice, the device may advantageously be such that the flow of electric current causes the moveable part to retract so that power is consumed only for the short periods of fitting the optical fiber.

Other versions may be envisaged in which the moveable part is moved by a piezoelectric effect, or very simply by a mechanical effect, for example with a touch tip.

Although not necessary, the retention of the optical fiber may be supplemented by depositing an adhesive ensuring that the optical fiber is definitively fastened in the groove 2.

In general, the substrates used may be of the silicon-on-insulator (SOI) type machined using the conventional techniques.

It is apparent from the foregoing that the device according to the invention has many advantages:

the optical fiber can be optimally aligned with respect to a reference position;

the alignment can be adjusted as many times as is necessary, by moving the moveable part, without stressing the fiber;

the optical fibers are kept straight in their end segment thanks to the relatively great length over which the pressing force is exerted;

electrical power consumption is limited to the fiber-fitting phases alone.

1. A device allowing the end (4) of an optical fiber (3) to be positioned and held in place inside a substrate (1), wherein:
the substrate (1) has a groove (2) intended to accommodate the end (4) of the optical fiber (3), said groove (2) possessing at least one plane wall (8) perpendicular to the principal plane (9) of the substrate (1);
the groove (2) includes a moveable part (5), located on the face opposite the plane wall (8) and capable of moving toward said plane wall (8) between two positions, namely;
a retracted position in which the end of the optical fiber (3) can penetrate freely into the groove (2);
a locked position in which the moveable part (5) comes into contact with the optical fiber (3) in order to press it against said plane wall (8);
it includes means (21, 24) allowing a force to be exerted on the moveable part (5) in order to cause it to move with respect to the plane wall (8).

2. The device as claimed in claim 1, which also includes return means (17, 18) capable of opposing any movement of the moveable part under the action of said force.

3. The device as claimed in claim 1, wherein the means allowing a force to be exerted on the moveable part allow the moveable part to move from the retracted position to the locked position.

4. The device as claimed in claim 1, wherein the means allowing a force to be exerted on the moveable part allow the moveable part to move from the locked position to the retracted position.

5. The device as claimed in claim 2, wherein the return means are formed by two beams (17, 18) made in the substrate, which connect the moveable part (5) to the rest of the substrate (1), said beams (17, 18) being oriented approximately parallel to the principal axis (6) of the groove (2).

6. The device as claimed in claim 1, wherein the force exerted on the moveable part is electro-static in nature.

7. The device as claimed in claim 6, wherein the means for exerting the force on the moveable part comprise two arrays of blades (22, 23) forming two interdigitated combs (21, 24), one (21) of these combs being integral with the moveable part and the other comb (24) being integral with the rest of the substrate (1), application of an electrical voltage between the two combs (21, 24) causing them to move closer together.

8. The device as claimed in claims 2, 4 and 7, wherein application of the electrical voltage causes the moveable part (5) to pass from the locked position to the retracted position, removal of this voltage allowing the return means to cause the moveable part (5) to return to the locked position.

9. The device as claimed in claims 2, 3 and 7, wherein application of the electrical voltage causes the moveable part to pass from the retracted position to the locked position, removal of this voltage allowing the return means to cause the moveable part to return to the retracted position.

10. The device as claimed in claim 1, wherein the force exerted on the moveable part is electrothermal, piezoelectric, magnetostatic or mechanical in nature.
